(19) United States
(12) Patent Application Publication
(10) Pub. No.: US 2019/0096001 A1
(43) Pub. Date: Mar. 28, 2019

(54) PLATFORM IMPLEMENTING RETROSPECTIVE LOSS POOLING

(71) Applicant: Eusoh, Inc., Beverly Hills, CA (US)

(72) Inventor: Allen Kamrava, Beverly Hills, CA (US)

(21) Appl. No.: 16/141,818

(22) Filed: Sep. 25, 2018

Related U.S. Application Data
(60) Provisional application No. 62/562,814, filed on Sep. 25, 2017.

(51) Int. Cl. G06Q 40/08; G06Q 50/18

(52) U.S. Cl. CPC G06Q 40/08; G06Q 50/188

(57) ABSTRACT

A retrospective loss pooling platform and associated method creates an automated loss pooling mechanism for groups that will cost share on demand while further shedding the expense burden associated with insurance company operations and regulatory compliance. The systems and methods implement retrospective loss pooling of expenses for payment by using one or more processors to create loss pool groups of members that are contractually obligated to collectively pay the expenses of other members in respective time periods in response to expenses received from the members of the group in the respective time periods, receive and validate expenses submitted by the group members in a given time period, and cause payment of expenses received and validated in the given time period from payment accounts of respective members in the group in accordance with the group's contractual obligations. Significantly, the given time period occurs prior to payment so that the payment amounts are not speculative.

### CROSS-REFERENCE TO RELATED APPLICATIONS

This patent application claims the benefit of U.S. Provisional Patent Application No. 62/562,814, filed Sep. 25, 2017, by Allen Kamrava, and titled “Platform Implementing Retrospective Crowdfunding,” which is hereby incorporated by reference in its entirety.

### TECHNICAL FIELD

Embodiments of the present disclosure relate generally to data processing and, more particularly, but not by way of limitation, to a platform that implements retrospective loss pooling to pay the expenses of members of an expense-sharing platform.

### BACKGROUND

Conventionally, insurance companies, with a “revenue as a function of throughput” income structure, have an incentive structure opposite of their customers' needs—that is, their annual report of revenue to shareholders is directly proportional to their premiums. The higher the premiums, the better their annual report, which disincentivizes them to fight inflated costs. Consequently, premiums have witnessed exponential growth, while the coverage provided has inversely demonstrated narrowing networks. Compounding the problem, the availability of physicians willing to accept the “negotiated” rates by health insurers is decreasing at an accelerating rate. As a result, it has become increasingly difficult for patients to see their Service Providers of choice. Insurance premiums and deductibles have exponentially outpaced inflation and patients are paying more for insurance and using it less to avoid the deductibles. Though there is much contention on how to fix the system, it is universally accepted that the current system is an unmitigated failure.

At its core, insurance is crowdfunding done on a prospective basis. Premiums paid today are saved to pay for future services. The present inventor is not aware of a solution that offers loss pooling done retrospectively, as it is predicated on a system that can provide a promise-to-pay. To date, self-funded exchanges acted prospectively as well, since otherwise they would be appealing for people's good will to donate. A system is desired that does not require pooling of peoples' monies. In such a platform, no monthly set premium to form a group fund is necessary, and thus it completely decouples that misaligned linkage plaguing the prospectively based insurance market.

Another significant part of the cost problem is that for an insurance company to operate, it must perform the following functions and charge customers for the associated costs:

Marketing—an insurance company utilizes a paid distribution network (i.e., agents and brokers);

Underwriting;

Loss control;

Actuarial (rate-making);

Premium audit;

Health care provider network selection and management;

Regulatory filings and management;

Claims settlement;

Investment of reserves; and

Accounting and Finance.

By using a software crowd sourcing platform that eliminates the need for a paid distribution network, shares retrospective expenses for selected loss pools to eliminate the need for underwriting, actuarial work, and premium audits, and uses automation to enable members to choose their own service providers and to negotiate their own prices, the inventor submits that these costs can be eliminated and bring market forces back, and at scale. However, to do so, a need exists for a robust retrospective loss pooling platform as opposed to a conventional prospective crowdfunding platform as conventionally used in the art. The systems and methods described herein provide such a retrospective loss pooling platform and show how such a platform may be used to create membership groups, negotiate pricing, and manage payment obligations for members of respective groups and alliances without the significant overhead and money pooling associated with conventional prospective payment processes implemented by the insurance industry. The resulting platform is computationally efficient compared to existing platforms in that the resulting computations are based on actual costs, rather than projections, thereby eliminating the significant computational costs of existing platforms. Also, a platform that facilitates the formation of members into expense sharing groups improves the overall organizational structure of the computer processing operations. A sample implementation for the healthcare market will be described herein, although it will be appreciated that the platform may be used for other applications that would benefit from crowd-sharing of expenses and more predictable costs.

### SUMMARY

Various examples are now described to introduce a selection of concepts in a simplified form that are further described below in the Detailed Description. The Summary is not intended to identify key or essential features of the claimed subject matter, nor is it intended to be used to limit the scope of the claimed subject matter.

The systems and methods described herein address the needs in the art by re-introducing market mechanisms into systems now devoid of them and by creating an automated loss pooling mechanism for self-selected groups that will cost share on demand while further shedding the expense burden associated with insurance company operations and regulatory compliance. The systems and methods described herein also provide a computer platform that decouples revenue from throughput, creates data structures to guarantee a promise to pay, and reintroduces market forces where insurance companies had eliminated them.

The systems and methods described herein provide a retrospective loss pooling platform that may be used to support a software as a service model that allows self-selected groups to form for the purpose of loss pooling. In the healthcare services sector, the platform supports a reimbursement model that returns market dynamics to an overly regulated industry, aligns interests and rewards, and reduces significantly the frictional/administrative costs now burdening patients and providers alike. By way of example only, other applications of the retrospective loss pooling platform described herein include everyday products and services such as cell phone warranties, veterinary care, healthcare expenses, and costs experienced in niche luxury areas such as racehorses, airplane fuselages for private planes, and physical damage coverage for cars participating in ride-sharing services.

Due to how it operates, when applied to an industry, such as healthcare, the retrospective loss pooling platform described herein enables the application of market mechanisms for pricing, which are instrumental in bringing down cost. On the administrative side, an estimated 20-40% of every dollar that goes through an insurance company is lost in administrative work. Significant gains will be enabled by operating on the market side. That is to say, a platform that works on the market side will reduce the overall cost to a member on the order of 60-90% compared to what they are paying now.

To gain such advantages, the platform provides data structures that enable the automated creation of user expense groups, sectors, and alliances and the agreements among the respective groups, sectors, and alliances enforcing the promises to pay the expenses of the respective members of the respective groups, sectors, and alliances. Data structures are also provided for tracking the expenses of the respective groups, sectors, and alliances to calculate the responsibilities of each member for each expense time period.

A retrospective loss pooling platform in a sample embodiment addresses these and other needs in the art. The platform includes a processor, a display interface, and a memory that stores instructions that, when executed by the processor, implement retrospective loss pooling of expenses for payment. The method implemented by the processor includes the steps of creating a first data structure comprising loss pools of groups of members that are contractually obligated to collectively pay the expenses of other group members in respective time periods in response to expenses received from the members of the group in the respective time periods, creating a second data structure for receiving and validating expenses submitted by the group members in a given time period, and the second data structure causing payment of expenses received and validated in the given time period from payment accounts of respective members in the group in accordance with the group's contractual obligations. Importantly, the given time period occurs prior to payment so that the amount paid is for actual expenses, not expenses estimated by actuaries. To further control costs, the first data structure enforces contracts of service costs for the group negotiation on behalf of the individual members of the group with the system providing real-time information to all members of reasonable costs and the expenses are paid in accordance with the negotiated service costs. In sample embodiments, the group of members is combined into an alliance with at least one other group to disperse service costs to a wider group of members and the expenses are paid proportionally by the group and the alliance.

In sample embodiments, the platform includes a database that stores a profile for each member of the group, each member profile including each member's group costs for previous time periods, as well as each member's alliance costs incurred as a result of the alliance formed with the at least one other group. Also, in sample embodiments, the group's contractual obligations include a limit that a member may pay in the given time period and the second data structure pulls payment from the alliance when the group's costs in the given time period exceeds the groups' members' limits. Also, the display interface enables the members of the group to manage membership of the group through a new member approval process and an expense challenge process.

Corresponding methods implemented by the retrospective loss pooling platform as well as computer readable storage media including instructions for implementing such methods are also described and claimed herein.

### BRIEF DESCRIPTION OF THE DRAWINGS

Various ones of the appended drawings merely illustrate example embodiments of the present disclosure and cannot be considered as limiting its scope.

FIG. 1 illustrates how the costs disperse out for members of a retroactive loss pool implemented in accordance with a sample embodiment.

FIG. 2 illustrates sample cost calculations for members of a sample member Group.

FIG. 3A illustrates the variables identified in FIG. 2 and the equations applied to the variables identified in FIG. 2.

FIG. 3B illustrates descriptions of the variables identified in FIG. 2.

FIG. 4 illustrates a sample embodiment of a server platform for use in a high-level client-server-based network architecture.

FIG. 5 illustrates a physical infrastructure diagram for a system implementing the architecture of FIG. 4 in a sample embodiment.

FIG. 6 illustrates sample security reference architecture in a sample embodiment.

FIG. 7 is a flow chart illustrating an embodiment of software applications used to create data structures of Groups of members and enabling members to join Groups in a sample embodiment.

FIG. 8 is a flow chart illustrating further data structures for calculating and paying expenses in a sample embodiment.

FIG. 9 illustrates the process of dissolving a Group in a sample embodiment.

FIG. 10 illustrates sample data structures for an automated retroactive loss pooling platform for managing expenses in a sample embodiment.

The headings provided herein are merely for convenience and do not necessarily affect the scope or meaning of the terms used.

### DETAILED DESCRIPTION

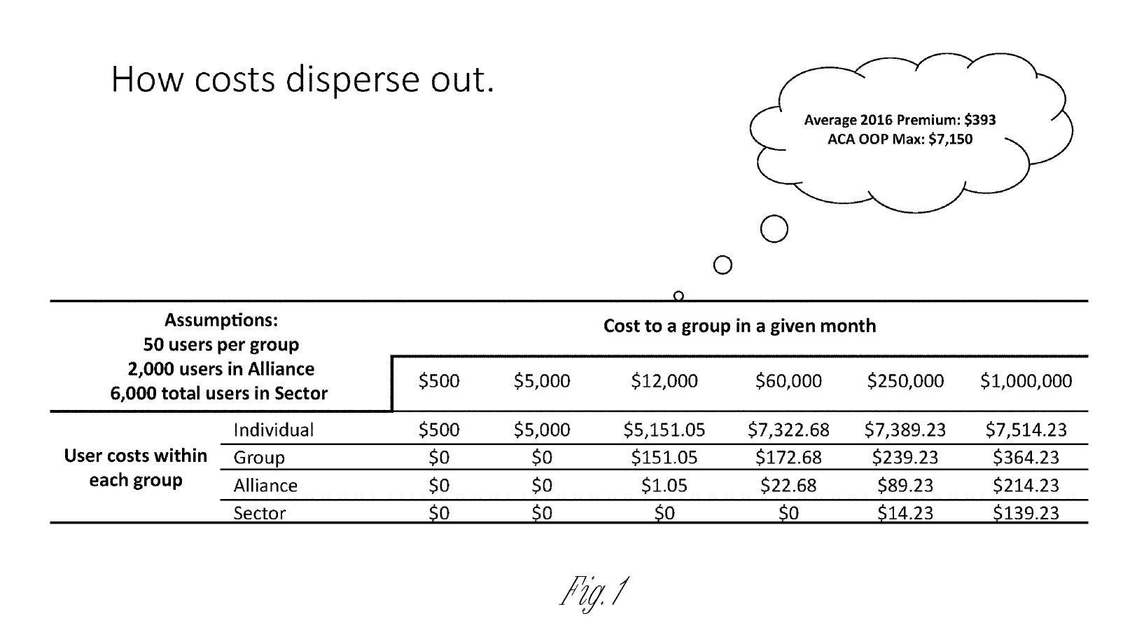

The description of FIGS. 1-10 that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

The underlying financial premise of a retrospective loss pooling system is that members' aggregated, “personal balance sheets” may be substituted for the balance sheets and reserves of an insurance company. The systems and methods described herein may be used to manage the functions required for effective loss pooling for the members of the Groups within the platform. Examples will be provided below for a sample healthcare platform, although it will be appreciated that other applications of the retrospective loss pooling platform described herein include everyday products and services such as cell phone warranties, veterinary care, healthcare expenses, and costs experienced in niche luxury areas such as racehorses, airplane fuselages for private planes, and physical damage coverage for cars participating in ride-sharing services.

### Member Selection Criteria

On the surface, the system should be indifferent to a member's likely healthcare costs. For example, if an adversely selected Group (i.e., 50 obese people with diabetes and cardiac conditions) want to pool risk, the platform acts indifferently.

1. System design impacts on member selection:
a. Groups self-select by membership voting with whom they wish to associate.
b. Track records—user profiles maintain their spending records. How much have they contributed versus taken out from the system? And how frequently (i.e. was it a singular large event, such as a car accident, or an ongoing poor health maintenance)?
c. Shared Social Responsibility—with insurance products, there is no shared responsibility or need to control costs to the insurers. In a community setting, shared social responsibility provides the opposite effect.

2. Alliance Self Selection—Once the system reaches adequate scale to accommodate it, the Alliances can select which Groups to associate with to scale higher monthly costs. Groups that have pooled high-risk users together may never be able to form an Alliance, leading to Group dissolution and member re-distribution into other Groups.

The selection criteria are typically provided to the Groups, and they choose how to put them in place. In other words, the members are the ones establishing their selection processes and the agreement(s) each member of the group is to enter into to become a member of the group. For example, the member agreements may specify what services are covered and not covered in order to manage the costs for members of the group. The platform itself is completely indifferent.

By way of example, community-based scaling may be provided as follows. John joins the platform and decides to join a “Lawyer” Group having 49 members, making John the 50^{th} member. The Lawyer Group has a 50-member Group in a virtual community that covers one another for day-to-day healthcare costs. The Lawyer Group may align with 40-50 other Groups to form an Alliance whose members cost share for unplanned events that cost more than day-to-day costs. The Sector would be everyone in that system category, where everyone contributes for rate and catastrophic events. Thus, as the rarity and cost of an event increases, the scaling increases the number of people who would contribute to cover the cost.

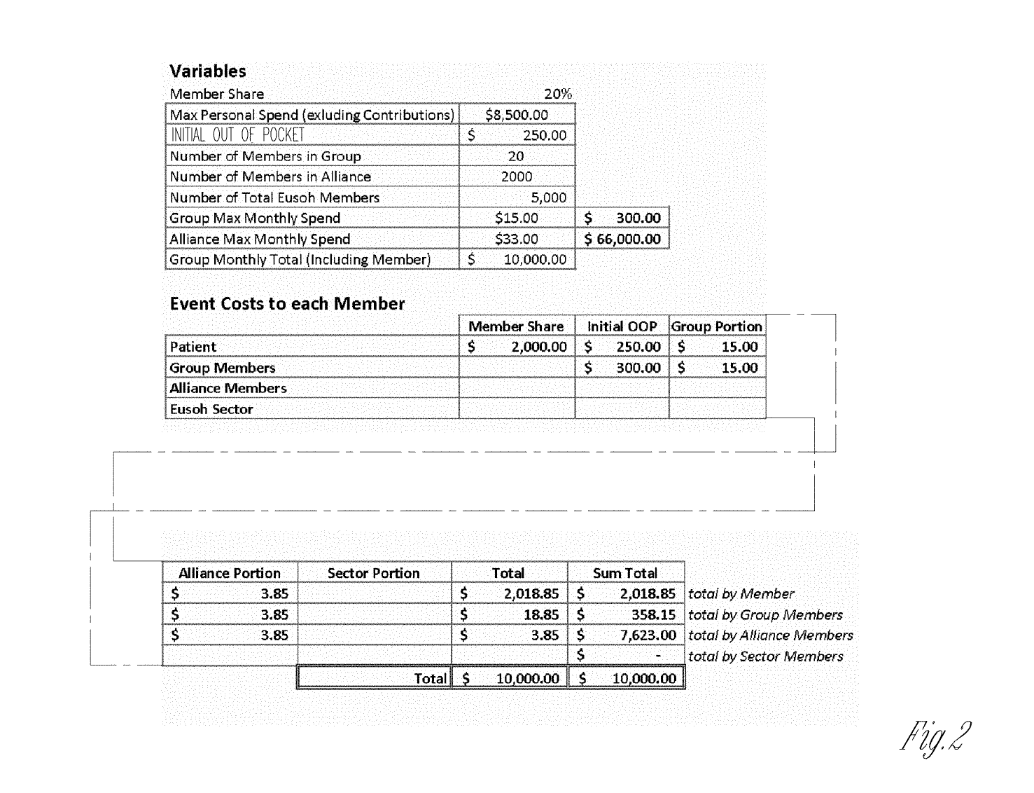

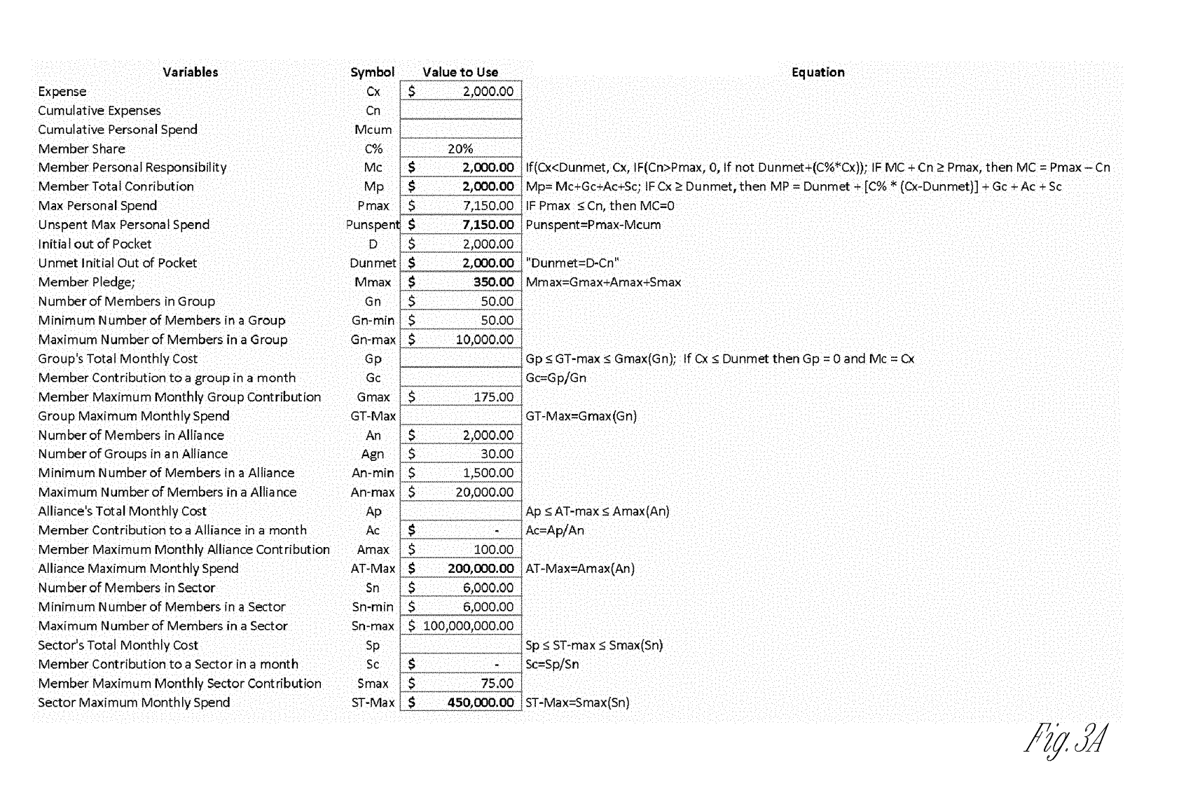

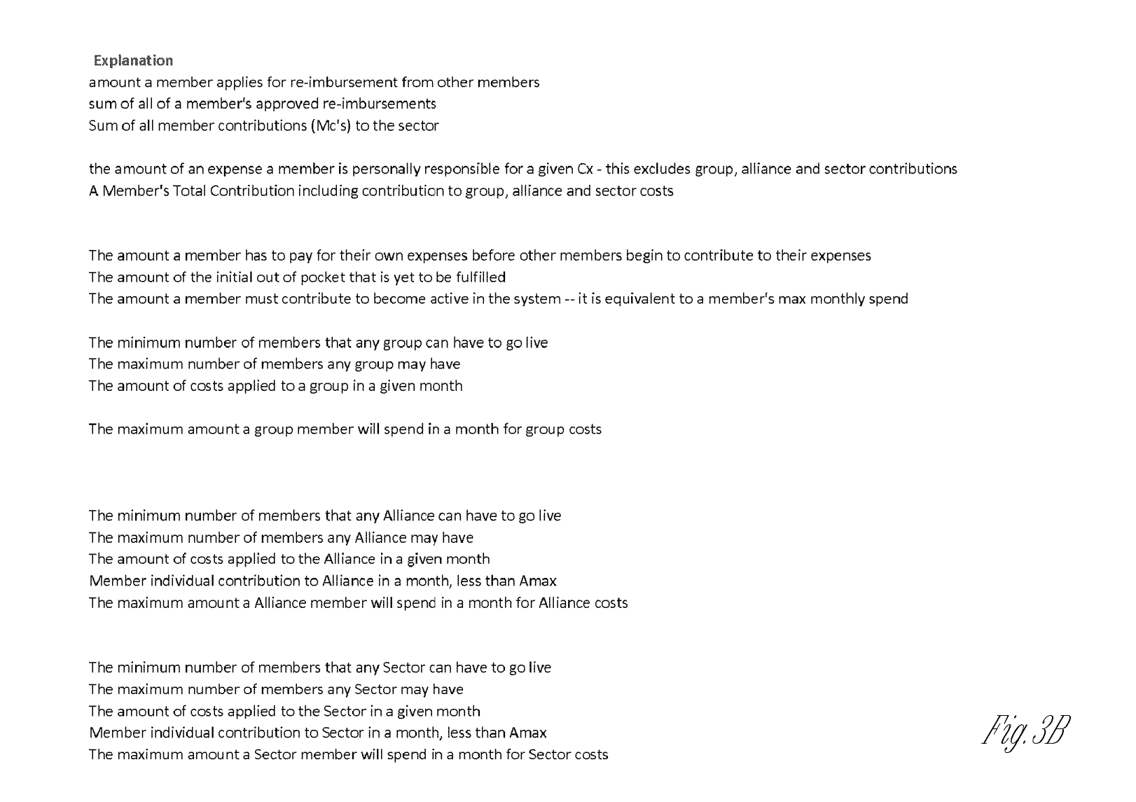

FIG. 1 illustrates how the costs disperse out in this fashion, while FIG. 2 illustrates sample cost calculations for members of a sample member Group given the variables identified in FIGS. 3A-3B. The systems and methods for managing these costs and associated payments mechanisms will be described in more detail below.

### Retrospective Loss Pooling Platform

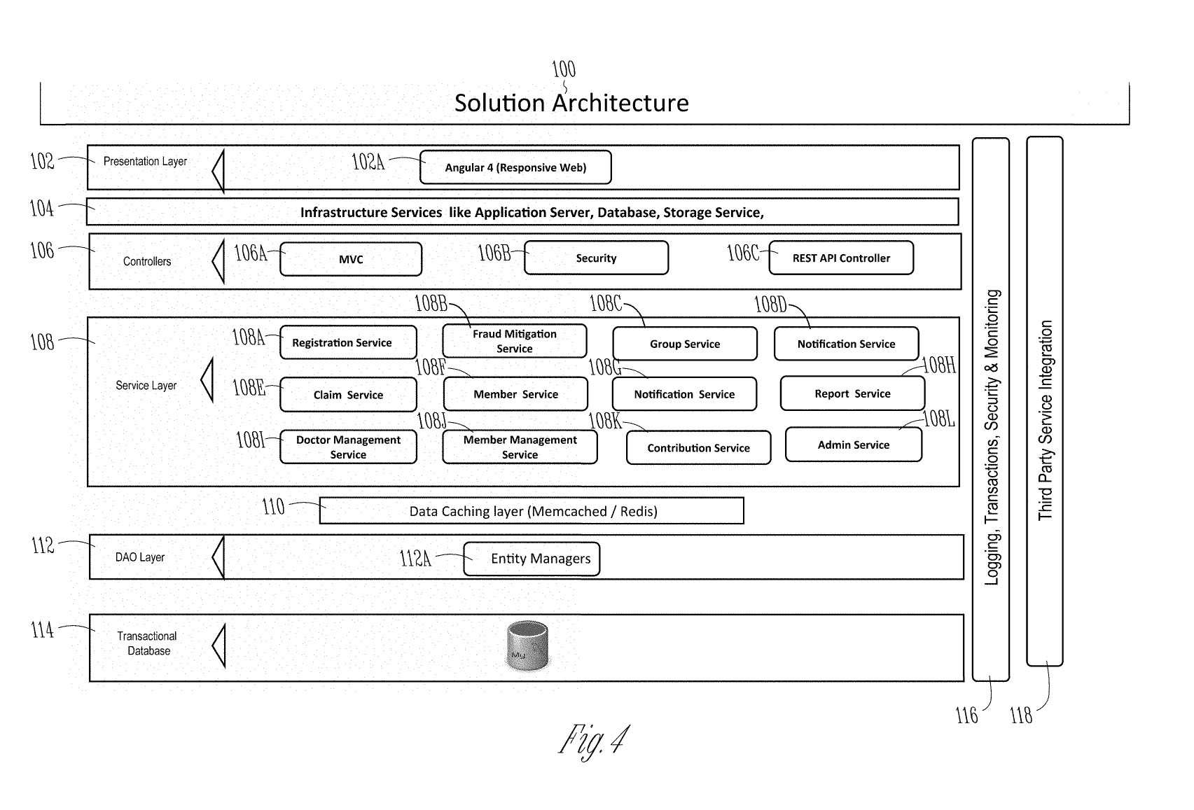

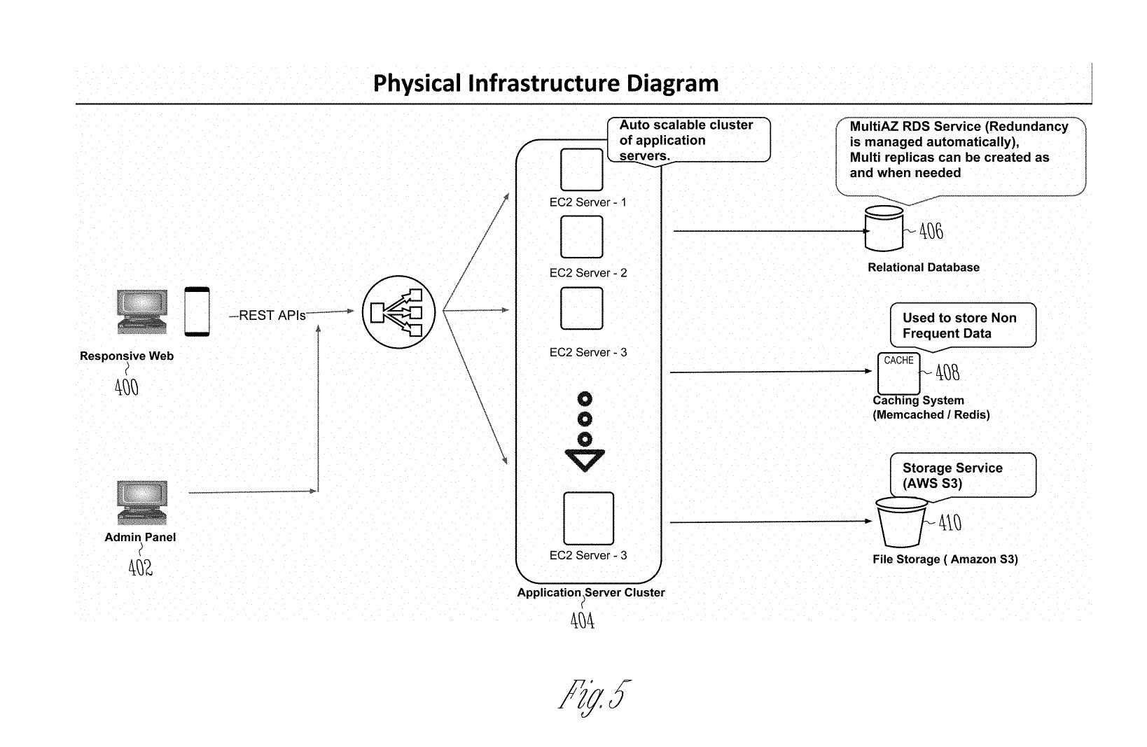

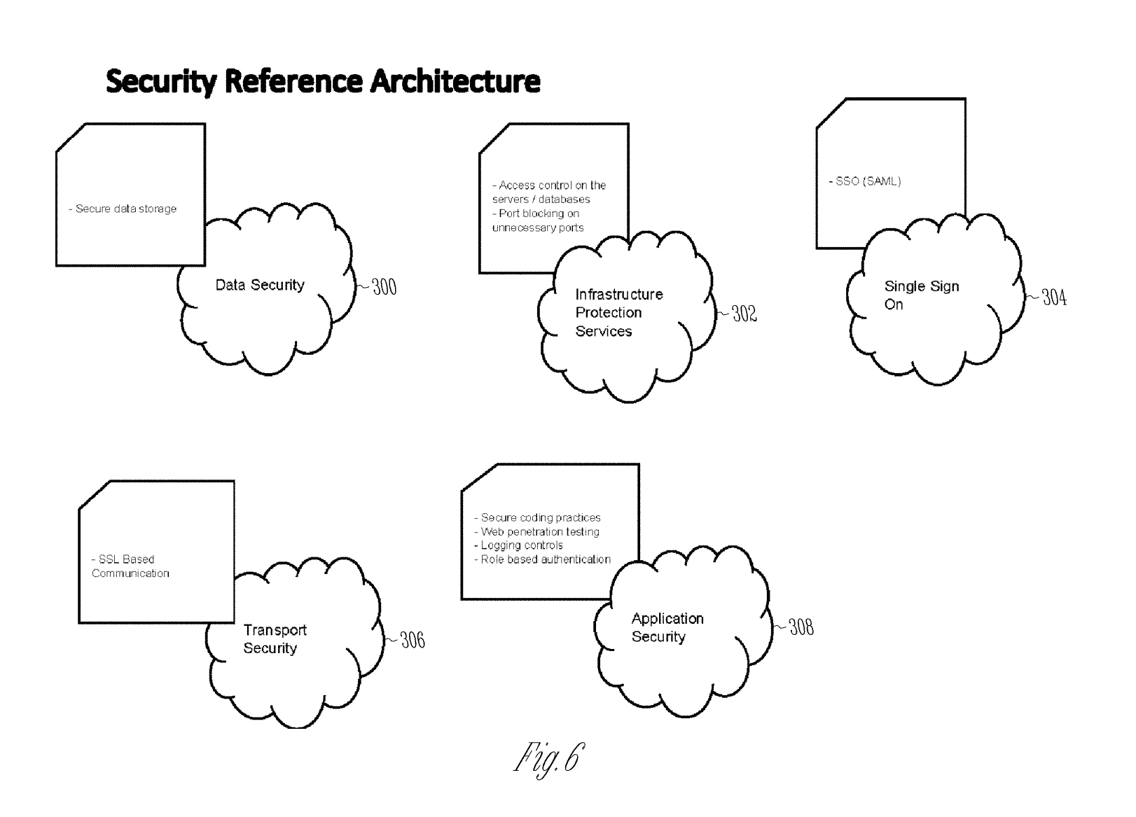

With reference to FIG. 4, an example embodiment of a server platform 100 for use in a high-level client-server-based network architecture is shown. As illustrated, the server platform 100 implements a presentation layer 102 including a responsive web infrastructure 102a (FIG. 5), infrastructure services 104 such as an application server, database, and storage service (FIG. 5), controllers 106 including a Model View Controller (MVC) 106a, a security controller 106b (FIG. 6), and a Representational State Transfer (REST) API Controller 106c (FIG. 5), a service layer 108, a data caching layer 110 (FIG. 5), and a data access object (DAO) layer 112 including entity managers 112a that communicate with a transactional database 114. As indicated, the service layer 108 may implement a number of services including registration service 108a, fraud mitigation service 108b, group service 108c, notification service 108d, claim service 108e, member service 108f, notification service 108g, report service 108h, doctor management service 108i, member management service 108j, contribution service 108k, and administrative service 108l. The server platform 100 supports functions including logging transactions, security, and monitoring 116. Third-party service integration interface 118 provides an interface to third party services.

FIG. 5 provides a physical infrastructure diagram for a system implementing the architecture of FIG. 4. As illustrated in FIG. 5, the responsive web infrastructure 400 and administrator panel 402 communicate with the application server cluster 404 through APIs, and the application server cluster 402, in turn, stores/retrieves data from relational database 406, caching system 408 for storing non-frequent data, and file storage service 410. The administrative panel may be implemented using HTML, CSS, and jQuery functionality in sample embodiments.

FIG. 6 illustrates sample security reference architecture in a sample embodiment. As illustrated, data security software 300 provides secure data storage, infrastructure protection software services 302 provide access control on the servers and databases of the system of FIG. 4 and blocks unnecessary ports. On the other hand, login software 304 provides a single sign on (SSO), and transport security software 306 supports SSL communication. Also, application security software 308 supports secure coding practices, web penetration testing, logging controls, and role-based authentication. Those skilled in the art will appreciate that other security services may be provided on an as-needed basis.

Referring back to FIG. 4, the identified structures may be implemented using a variety of known technologies. For example, the backend system including presentation layer 102 may be implemented using a proprietary PHP7 framework with an Angular 4 responsive web infrastructure. The transactional database 114 may be implemented using MySQL for relational data like users, payments, inventory, and the like, while the data caching layer 110 may be implemented using Redis/Memcached in sample embodiments. In addition, the infrastructure and server may be implemented using Amazon Web services as PaaS, where EC2 is used for servers, RDS for databases, S3 for storing media files, and ELB for load balancing. The webserver may be a conventional Apache webserver. Git may be used for source control and SONARQUBE for static code review. Finally, monitoring and profiling services may be provided using Amazon Cloudwatch to provide detailed graphs about different usage statistics of processes like CPU, memory, etc., and JMeter may be used for load testing of the applications.

In sample embodiments, third parties may use devices including, but not limited to, a mobile phone, desktop computer, laptop, portable digital assistants (PDAs), smart phones, tablets, ultra-books, netbooks, laptops, multi-processor systems, microprocessor-based or programmable consumer electronics, game consoles, set-top boxes, or any other communication device that a user may utilize to access the networked system 100. In some embodiments, the client device used by third parties may comprise a display module (not shown) to display information (e.g., in the form of user interfaces). In further embodiments, the client device used by third parties may comprise one or more of touch screens, accelerometers, gyroscopes, cameras, microphones, global positioning system (GPS) devices, and so forth. The client device used by third parties may be a device of a user that is used to perform a transaction involving digital items within the networked system 100. In one embodiment, the networked system 100 is a network-based marketplace that responds to requests for available member Groups, publishes publications comprising service cost listings, enables search and evaluation of Groups available on the network, and manages payments for any transactions using, for example, e-commerce payment processing platforms. One or more users may be a person, a machine, or other means of interacting with the client device of the third parties. In embodiments, the user is not part of the network architecture 100 but may interact with the network architecture 100 via the client device or by other means. For example, one or more portions of the network including network architecture 100 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMAX network, another type of network, or a combination of two or more such networks.

Each of the client devices may include one or more applications (also referred to as “apps”) such as, but not limited to, a web browser, messaging application, electronic mail (email) application, an e-commerce site application (also referred to as a marketplace application), and the like. In some embodiments, if the site application is included in a given client device, then this application is configured to locally provide the user interface and at least some of the functionalities with the application configured to communicate with the networked system 100, on an as needed basis, for data and/or processing capabilities not locally available (e.g., access to a database of available member Groups, to authenticate a user, to verify a method of payment, etc.). Conversely if the site application is not included in the client device, then the client device may use its web browser to access the site (or a variant thereof) hosted on the networked system 100.

In sample embodiments, the user may interact with the network architecture 100 via the client device or other means. For instance, the user provides input (e.g., touch screen input or alphanumeric input) to the client device and the input is communicated to the networked system 100. In this instance, the networked system 100, in response to receiving the input from the user, communicates information to the client device via a network such as the Internet to be presented to the user. In this way, the user can interact with the networked system 100 using the client device.

An application program interface (API) server 104 and a web server 102 are coupled to and provide programmatic and web interfaces respectively to one or more application servers (not shown). The application servers may host one or more publication systems and payment systems, each of which may comprise one or more modules or applications and each of which may be embodied as hardware, software, firmware, or any combination thereof. The application servers are, in turn, coupled to one or more database servers that facilitate access to one or more information storage repositories or database(s) 114. In a sample embodiment, the databases 114 are storage devices that store information to be posted (e.g., publications or listings) to a publication system. As explained further below, the databases 114 may also store digital information about available services with price listings and available member Groups in accordance with sample embodiments.

The publication systems may provide a number of publication functions and services to users that access the networked system 100. A payment system may provide a number of functions to perform or facilitate payments and transactions. While a publication system and payment system may both form part of the networked system 100, it will be appreciated that, in alternative embodiments, each system may form part of a payment service that is separate and distinct from the networked system 100. In some embodiments, the payment systems may form part of the publication system.

Further, while the client-server-based network architecture 100 shown in FIG. 4 employs a client-server architecture, the present inventive subject matter is of course not limited to such an architecture, and could equally well find application in a distributed, or peer-to-peer, architecture system, for example. The various systems described herein could also be implemented as standalone software programs, which do not necessarily have networking capabilities.

Additionally, a third-party application executing on a third-party server may have programmatic access to the networked system 100 via the programmatic interface provided by the application server 200. For example, the third-party application, utilizing information retrieved from the networked system 100, may support one or more features or functions on a website hosted by the third party. The third-party website may, for example, provide one or more promotional, marketplace, or payment functions that are supported by the relevant applications of the networked system 100.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described herein are implemented in some embodiments in the context of a machine and an associated software architecture, although it will be appreciated by those skilled in the art that the system may also run on multiple platforms including servers, mobile phones, and the like. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. As described above, another combination produces a server computer for use within a cloud computing architecture. Not all combinations of such software and hardware architectures are presented here as those of skill in the art can readily understand how to implement the invention in different contexts from the disclosure contained herein.

### Software Architecture

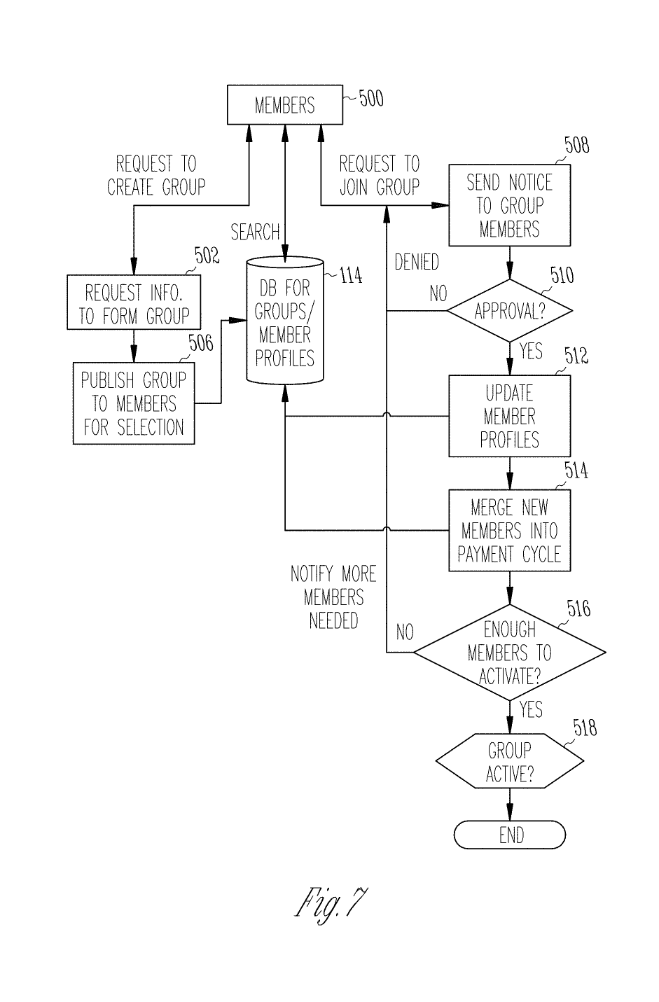

FIG. 7 is a flow chart illustrating an embodiment of software applications used to create data structures of Groups of members enabling members to join Groups in a sample embodiment. As noted above, unlike convention insurance financial platforms where premiums are pooled for investment and losses are managed, the data structures described herein pool Group expenses from a prior time period for members of the group during the relevant time period. As illustrated, members 500 may request to create a Group. When such a request is received, the system requests the information from the members required to form the data structure for the Group at 502. For example, members should be able to create a new Group by entering following information:

Name

Description (limited to X characters)

Choice of one or more pre-defined packages

The pre-defined packages typically incorporate service costs (by SERVICE) that ideally include the average cost for a service for a zip code provided by the member. Once the Group is formed, it is stored as a data structure and published to potential members for selection at 506. The published Group should start appearing in the Group feed immediately and the member is prompted to sign up/into the platform to be able to join or create a Group. For example, the data structure including the Group information may be stored in database 114 for search and selection by members 500. During the search, the member should be able to view a feed of Groups. At least the following information should be seen for each Group provided by the data structure:
Name of Group
Description (limited to X characters)
Initial Out of Pocket (can be customized by groups)
Member contribution percentage (can be customized by groups)
Number of members in the Group
Average age of members who are a part of the Group
Contribution needed to join the Group
Monthly contribution date
   The Groups found in the search may be sorted in the following order from the top:
Groups which fall below minimum number (and are still below minimum) of members over past X days;
Groups closest to being live (about to reach the minimum number needed to be live);
Groups which are live but closest to the minimum Group requirement;
Groups farthest from being live; and
Groups which are live but farthest from the minimum Group requirement.

The data structure enables the member to filter the feed by selecting one or more packages. All those Groups which include all the selected packages should be presented by the data structure for selection. When selecting a Group, the data structure enables the members 500 to navigate to view the following details:
List of services included
Name of each service
SERVICE code for each service
Average cost of service.
   Once a member 500 identifies a Group that he desires to join, a request to join the desired Group is sent (e.g. by email) by the data structure to the members of the Group at 508. The member's request to join would include the member's profile information as well as an introductory message from the member. The member would then be informed that the member's participation in the Group is dependent upon approval from existing members of the Group.
   The member who sent the join request should be able to view a list of approval requests received from different Groups which he is a part of. The following information should be seen for each such request:
Name of the Group
Name of the requesting member
Date and time at which the request was received
   Other members are able to select a requesting member to view all necessary details including:
Name of the Group
Name and age of the requesting member
Picture of requesting member
Date and time at which the request was received
Requesting member's answers to medical history quiz
Certain answers should only appear as ‘bad’ to other members if the requesting member had selected a response which was configured by the system as such
   For a requesting member who has been a part of at least one Group on the platform in the past, other members of the requested Group should be able to view the following information for the requesting member:
Name of the Groups they are/were a part of
For each such Group, following information should be seen:
Length of stay
Total amount contributed to date
Total amount reimbursed to date
Number of times the member or any of their expenses have been flagged by other Group members.

For each flagged expense of the requesting member, other members should be able to view details of the flags including:
Date on which the member was flagged
Type of flag
Reason added for flagging will not be visible
   Finally, the data structure enables the Group member to vote for or against another member who is requesting membership in their Group before the cut-off time. Based on the number of votes received before the cut-off time, if the majority of the votes are determined at 510 to be in favor of the requesting member, they should be added to the Group and the Group's member profiles in database 114 are updated by the data structure at 512. If the member's request to join the Group is denied, the member is so notified. For an accepted member, the new member's payment account is tied to the Group for inclusion in the upcoming payment cycle at 514.

At step 516, the system determines whether enough members have joined the Group for activation. If not, a notification is sent to indicate that more members are needed before the Group may be activated. On the other hand, as soon as a Group reaches its minimum number of members, the Group goes live at step 518 providing coverage to each individual member in the Group. The monthly contribution cycle for the Group is subsequently set for the end of month by the system. Any member who joins after a Group goes live gets protection as soon as their payment is made. However, all such members are subsequently merged into the monthly contribution cycle of the Group from the next payment onwards. So, for example, if a new member B joins the Group G just before A submitted their expense, B should be considered by the system while calculating contributions of each member at the end of the month towards expenses submitted while he was a live member of the Group in the month. If, however, B joins the Group after A has submitted the expense request, B is not liable to make any contribution towards A's expense or any past expenses. B can join the Group by paying a contribution amount needed to join the Group and only contribute to subsequent expenses. Note that the monthly contribution cycle is also the monthly payout date and all such members who have registered an expense (and got it approved) during an ongoing monthly cycle get paid on the monthly contribution cycle/monthly payout date as well.

Another data structure connects a new member of a Group with their payment account and makes the payment towards monthly pledge within X days from receiving an approval to join the Group. If no payment is received before the cut-off date, the member's approval for the Group is terminated. If this were a situation where this member was the last needed to make the Group live, as soon as the payment is made, the Group would be considered as live by the system at step 518. Also, as soon as the payment is made, respective members should now be covered for services under the Group and be able to submit an expense, if needed. A member willing to leave the Group now can do so by following the exit procedure (discussed below). The contribution cycle is auto set by the system to monthly from the month subsequent to the month in which the Group goes live. For example, if a Group goes live on August 10, a first contribution demand, if any, should be raised by the system on August 31. It may happen that a member makes a payment today but the Group goes live months after. In such case, the payment made would not provide any cover/benefit to such members. Members are informed about this risk at the time payment is made.

The contribution amount required to join a Group is uniform for all members across the platform and is derived from the following parameters managed by an administrator:
Contribution towards Group expenses—GMax
Contribution towards Alliance expenses—AMax
Contribution towards Sector expenses—SMax
Individual max contribution amount per month MMax=GMax+AMax+SMax
   The administrator also manages the following:
Minimum number of members needed to make a Group go live—GN-Min
Maximum number of members who can join a Group—GN-Max
Minimum number of members needed for the system to form an Alliance—AN-Min
Maximum number of members which can be a part of an Alliance—AN-Max
   The following are variables which depend on the number of members which are a part of the Group, Alliance and Sector in a sample embodiment:
Group spend maximum GT-Max—which is the maximum a Group can be charged against expenses in a month from its own members=GMax*GN, where GN is the number of members in the Group;
Alliance Spend Maximum AT-Max—this is the maximum amount an Alliance can bear for the charges coming from Groups in a month=AMax*AN, where AN is the number of members in the Alliance; and
Sector Spend Maximum ST-Max—this is the maximum amount a Sector can bear for the charges coming from Alliances in a month=SMax*SN, where SN is the number of members in the Sector.
   When a Group goes live with GN-Min, the total Group balance is calculated by the data structure to be GN-Min*Gₘₐₓ (see FIGS. 3A-3B).
   At any point of time later, the total Group balance <=GN*MMax. Similarly, when an Alliance is formed with AN-Min, the total Alliance balance=AN-Min*Amax. At any point of time later, the total Alliance balance <=AN*Amax.

By way of example, assume the following:

MMax=USD200=USD150(GMax)+30(AMax)+20(SMax)

GN-Min=50

Hence, when the Group goes live the Total Group balance=USD 200*50=USD 10,000. However, GT-Max=USD 150*50=USD 7,500. Now, consider that Alliance A is live with GN1, GN2, GN3, GN4 and GN5 under it:

GN1=50,GN2=55,GN3=60,GN4=65,GN5=70

AN-Min=250(This Alliance has 300 members)

Hence, AT-Max=USD 30*(50+55+60+65+70)=USD 9,000 Similarly, in the same example, say, composition of Alliances within a Sector is as follows: A1=300, A2=325, A3=275 (this Sector has 900 members). Hence, ST-Max=USD 20*(300+325+275)=USD 18,000. As more members join in the Group beyond the minimum number, their contribution MMax is added to Total Group Balance and has a direct increasing effect on GT-Max, AT-Max and ST-Max. Similarly, if a Group falls below its minimum number, the Total Group Balance reduces and has a direct decreasing effect on GT-Max, AT-Max, and ST-Max.

In the example above, let us assume the following:
Initial out of pocket for each member is USD 5,500
Member contribution is 25%
Out of Pocket (OOP) Max is USD 10,000
   If member A submits an expense for USD 7,500 which is approved by the Administrator, USD 5,500 is borne by A through initial out of pocket. USD 500 [(7,500-5,500)*25%] is borne by A through member contribution. USD 1,500 is paid from GT-Max bringing it down to USD 6,000. At the end of the month, each of the existing 50 members are required to pay USD 30 so that GT-Max is brought back to USD 7,500 (and Total Group Balance is brought back to USD 10,000).

In the example above, say, another expense is submitted by member B in the same month for USD 15,000 (and B already had consumed their initial out of pocket and OOP Max in earlier expenses). While USD 6,000 was available with the Group for reimbursement from GT-Max, remaining USD 9,000 are spread across the Groups which are part of the same Alliance. Consider that this Group belongs to Alliance C, which is live with GN1, GN2, GN3, GN4, GN5 and GN6 under it:

GN1=50,GN2=50,GN3=50,GN4=53,GN5=56,GN6=63

AN-Min=250(This Alliance has 322 members)

Hence, AT-Max=USD 30*(50+50+50+53+56+63)=USD 9,660. In this scenario, USD 9,000 is paid from AT-Max bringing it down to USD 660. This means that each member in the Alliance had to bear USD 27.95 (9000/322) towards the Alliance charge. Members of Group 1 together ended up paying USD 1,397.5 [27.95*50] towards this Alliance charge. At the end of the month, each of the existing 50 members are required to pay USD 178 [(7500+1397.5)/50] so that GT-Max is brought back to USD 7,500 (and Total Group Balance is brought back to USD 10,000). If that expense had been more than 660 higher, or if another expense was approved by the administrator which needed to be paid from the Alliance that the Alliance could not afford, the costs would be passed on to the Sector.

Now, consider that this Alliance belongs to Sector 1, which is live with AN1, AN2, AN3, AN4, AN5 and AN6 under it:

AN1=500, AN2=500, AN3=500, AN4=530, AN5=560, AN6=630 (This Sector has 3220 members.)

Hence: AT-Max=USD 20*(500+500+500+530+560+630)=USD 64,400. Any charge that would be pushed to Sector level that exceeds USD 64,400 at this level will be flagged to the administrator. While considering the approval, the administrator will not be able to approve it in total. The administrator will either manually choose to push an amount of the expense through the portal that the portal can afford or choose to reject it as far as the system is concerned and completely handle the reimbursement outside of the platform. In any case, a member cannot be charged beyond their MMax (discussed above). However, if a member experiences a cost that exceeds a published cost estimate for the services performed by a certain percentage (e.g., 20%), then the member could be held personally responsible for the amount in excess of the published cost estimate.

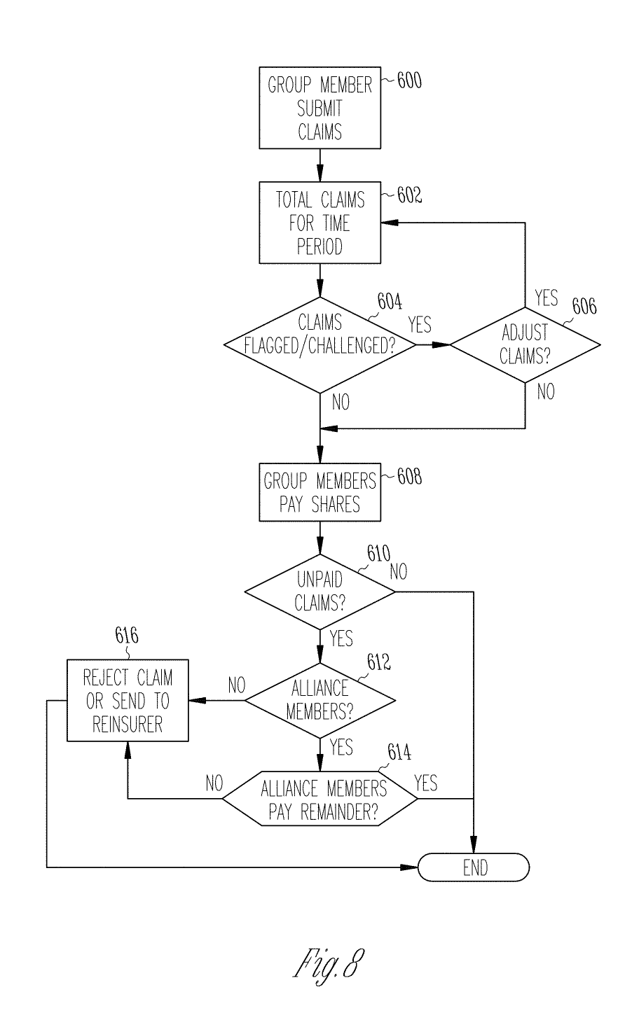

This expense and payment calculation process is implemented in a data structure reflected in the flow chart depicted in FIG. 8. As illustrated, Group members submit expenses at 600 and the total expenses for the time period are totaled at 602. As noted above, members have the opportunity to flag expenses to be challenged at 604 and any adjustments are made at 606. Once the expenses amount for the month is settled, the Group members pay their shares pursuant to their purchase contract limits at 608. If any expenses remain unpaid at 610, the system checks for Alliances at 612. If Alliances are found, the Alliance members pay the difference at 614. If all of the expenses still are not paid, the system may seek payment from Sector members as described above. If the expenses still are not completely paid, the expenses may be rejected, at 616 or else the payments may be deferred to a following month or covered by re-insurance. Additionally, each member that joins a group may be required to purchase a surety bond from an independent third-party in the amount of, for example, a maximum annual obligation, thus controlling costs and ensuring that members maintain their commitment to reimburse expenses during the term of their agreement with the group.

In sample embodiments, Groups are made a part of Alliances by the system by considering the following. As soon as the total number of members that sit between AN-Min and AN-Max across all of the Alliances in a Sector reaches AN-Min, a new Alliance will be formed of all such Groups which together have a membership>=AN-Min, if at all. However, the following preferences should be considered. At any point of time, an effort should be made to have equal number of Groups under all Alliances, and an effort should be made to have equal number of members across Groups under all Alliances. Effort also should be made to put Groups with identical packages together. It should be noted that until there are enough members on the platform to form the first Alliance on the platform, all such Groups are to be considered as a part of a singular Alliance by the system. Also, until there are enough Alliances on the platform (e.g. so that all Alliances can be formed out of the difference between AN-Min and AN-Max of all Alliances in a Sector), AN-Max should be set high enough that it allows Alliances to go far enough beyond 2*AN-Min so that as soon as an appropriate combination of Groups can be formed with at least AN-Min number of members under them, a new Alliance will be formed. It is further noted that Groups under an Alliance could keep on expanding towards their respective GN-Max and it is acceptable that a number of members in their parent Alliance exceeds AN-Max due to this. However, if a number of members in an Alliance exceeds AN-Max, no new Groups can be brought under it. This expansion process is managed by the data structure reflected in the flow chart depicted in FIG. 8.

If post formation of an Alliance a number of members in these Groups fall below AN-Min, the Alliance should continue to exist; however, the system makes best efforts to bring the number of members above AN-Min by looking for an Alliance in the same Sector where a Group can be moved out without bringing it below AN-Min and by putting any new Group which goes live under this Alliance.

On the other hand, if a Group is at its minimum, say 50 members, and a member exits the Group or does not make subsequent payment, the Group will still remain active. However, all such active members should be notified that the Group is now below its minimum mark. The same notification will also seek votes from the existing Group members if they wish to dissolve the Group in order to avoid bigger contributions. All such members will get X days to respond with “Yes” or “No.” If more than 50% of members who respond to the notification responds with a “Yes”, the Group should automatically dissolve after X days. If more than 50% of members who respond to the notification responds with a No, the Group should continue to survive with lesser number of members.

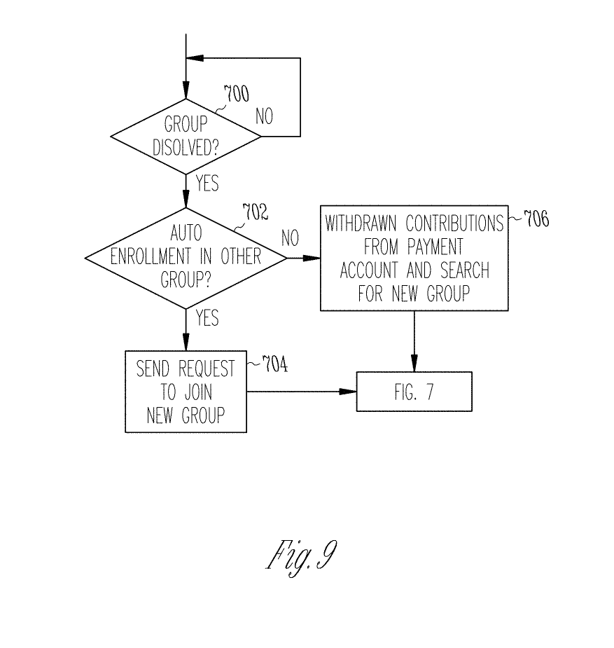

FIG. 9 illustrates the process of dissolving a Group. If it is determined at 700 that a Group is to be dissolved by its members, it is determined at 702 for each member if that member has auto-enrollment in another Group. If so, a request is sent to join that Group at 704 and the process described above with respect to FIG. 7 is followed. On the other hand, if the member does not have auto-enrollment in another Group, contributions by the member to his payment account is withdrawn at 706 and the member may return to the search interface to search for a new Group to join as described above with respect to FIG. 7.

Thus, if a member has opted for automatic enrollment into another similar Group in the event of dissolution of their current Group G, the system should automatically put forth their membership request into a Group K which is closest in the composition of service packages as that of the dissolved Group. However, respective member's entry into K is incumbent upon approval of the existing members as is the case when a membership request is initiated by the member. If the member's entry into K is approved by its members, either of the following could happen. If the member's existing contribution in G is less than individual spend maximum or initial contribution amount, the member should be informed to make the respective payment within next X days. On the other hand, upon rejection by majority of K's members, the respective member's existing contribution amount should be made available for withdrawal from their payment account. If the member has not opted for automatic enrollment into another Group upon dissolution, the respective member's existing contribution amount should be made available for withdrawal from their payment account and they should be able to search for a new Group on their own, if desired.

In sample embodiments, a member should be able to submit an expense by entering following information: uploading up to X photos from a local system or by camera/gallery and uploading up to Y documents from a local system. While some of the uploaded photos and documents could be supporting information, the rest of them are to be uploaded as receipts and the following information should be filled out for each one so the administrator can easily check the receipts against the filled in information: Service Provider's name (text) and SERVICE code of each service for which expense is being requested; cost incurred against each entered service; and date of receipt. If this date is older than current date by more than X days, the system will not accept the expense request and inform the member to submit costs and documents which are not older than X days. If this date is older than the date the member became a part of the respective Group, the system should not accept the expense request and inform the member to submit costs for expenses which were incurred post their joining the Group.

After a member has entered cost beside a SERVICE code, the system should save the data set (Date, Service Provider, SERVICE code, Cost), then the system should validate if that particular SERVICE code is included by this Group's packages. If not included, the system should strike out this SERVICE code line and place a link to the Group's package details beside it and let the user continue (however, all such data of entered SERVICES codes and their respective Service Provider, date and cost as entered by the member should be saved in the database). If not included, the system will not count any of this service's cost to an initial out of pocket. The member should be able to mark one or more services as private and the respective services should not be visible to other members of the Group while still being visible to the administrator. Also, the member should be able to view ‘Contact Us’ options to seek the Administrator's help, if needed. It is noted that an expense should be submitted even if it is completely covered by a member's initial out of pocket and nothing is to be reimbursed. Unless such expenses are submitted, a member's initial out of pocket for the year will not come down. Only the approved amount is settled against a member's initial out of pocket and not the entire amount which was submitted for an expense. If a member submits an expense in a Group with the same information (Service Provider, date, SERVICE code, cost) which was already submitted for an expense by the same member in the same or a different Group, the administrator should see all such expense requests as flagged.

For each service for which the integrated third-party portal returns an average cost of the respective service, the members should be displayed the same amount. If the entered cost for a service is higher than 100+X % (e.g., 20%) of returned average cost, the system should warn the member that only up to 100+X % of returned average cost shall be presented for reimbursement. If they are still below the initial out of pocket, 100+X % of their service cost is all that will count toward the initial out of pocket. If they need to pay co-coverage on this, it will be calculated from the 100+X % as the system will disregard any costs above 100+X %. A member should be able to view the available balance for the Group for the current month, and the following information should be seen for each expense that was submitted for approval this month, if any:

Name

Profile Picture

Only Processed and Approved expenses are shown here, each having comment added by the administrator, if any, the total amount reimbursed, the amount contributed by the member, the processing date, and for each service approved the SERVICE code and service description and amount reimbursed. For all the services marked as private by a member, the respective SERVICE codes and their description should not be displayed to other members.

The following information should be seen for each Alliance charge (processed only) which was levied on the Group, if any:

Date on which expense was processed

Amount which has been reimbursed

Amount contributed by the member

All SERVICE codes and service description for which expense was approved and claimed cost against each.

For a Sector charge levied on to the Group, the same information should be seen as seen for an Alliance charge. The list of charges should be paginated and sorted by processing date, and each member should be able to view contribution statistics for previous months as well.

Also, a member should be able to flag an approved expense for any of the members or an Alliance/Sector charge to the administrator if they want to seek clarification on any of the approvals. A member also should select a type of flag and add the reason for flagging (textual note limited to X characters). A member should only be able to flag a charge once.

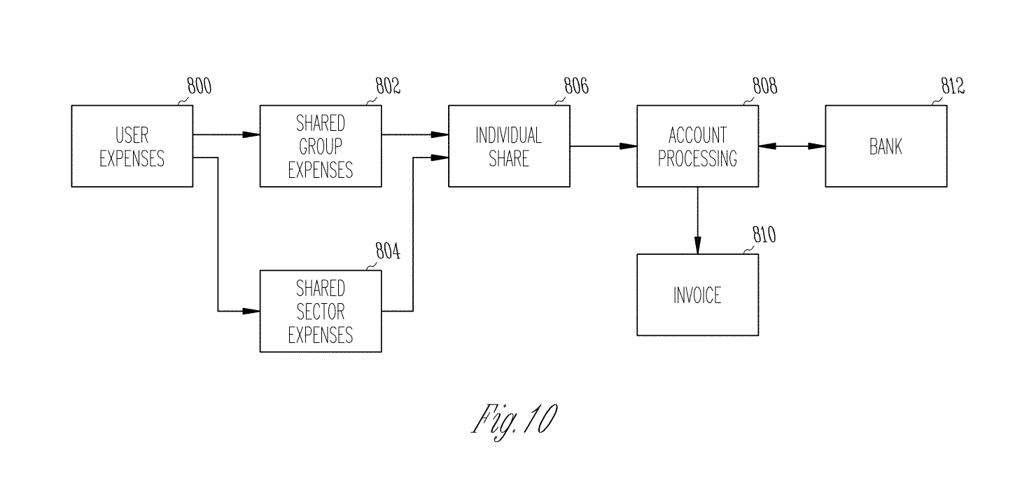

FIG. 10 illustrates sample data structures for an automated retroactive loss pooling platform for managing expenses in a sample embodiment. As illustrated, a first data structure 800 collects the expense data from individual members and provides the collected expense data to data structures for a group 802 the respective users belong to and a sector 804 the respective groups belong to based on the contractual arrangements entered into by each individual member. A second data structure that enforces the contractual promise to pay by each user comprises a computational block 806 calculates the users' individual shares of the expenses for the groups 802 and the sectors 804 using the calculations described in detail above and shown by way of example in FIGS. 1-3. The results of the calculations are forwarded to an account processing block 808 to generate invoices at 810 that are representative of the portion of the total expenses to be paid by the respective group and sector members. The account processing block 808 also performs the appropriate account transactions with bank 812 (e.g., ATM transfer).

It will be appreciated by those skilled in the art that the systems and method described herein are significantly less complicated and thus save significant amounts to processing power by processing actual costs instead of prospective actuarial costs. The resulting payment system is much less complicated as prepayment for services and pooling of money for later payment and reimbursements to multiple parties is not necessary as in conventional insurance-based healthcare scenarios, for example. The payment system is also significantly simplified as the middleman (insurance company) is removed and the platform may process all payments as actual amounts at the end of each reporting period.

Those skilled in the art will appreciate that the retrospective loss pooling platform described herein provides significant advantages over conventional insurance financial platforms. For example, while conventional insurance financial platforms introduce underwriting uncertainty that leads to implementation of complicated cost projection models, the retrospective loss pooling platform described herein does not require such complicated cost projection models. Rather, losses (as opposed to risks) are pooled using the data structures for groups, associations and sectors and payments are allocated using data structures that implement relatively straightforward calculations based on percentages agreed upon by the respective group members. Also, while conventional insurance financial platforms require loss control and claims management, actuaries, premium audits, regulatory filings, policy administration and receivables management, investment management, and provider networks that must be formed and managed, the retrospective loss pooling platform described herein is not affected by loss control management, so loss management is not required. Also, any auditing is performed up front and it not required on an on-going basis. Moreover, there is no need to invest and manage reserves as there are no reserves to invest or manage. The retrospective loss pooling platform described herein creates the data structures for obtaining and managing the expense claims, managing the contractual relationships amongst the groups, associations, and sectors, and managing the payment process. It will be appreciated that significantly less computer resources are required for such activities compared to the conventional insurance financial platforms.

### Example Machine Architecture and Machine-Readable Medium

Those skilled in the art will appreciate that in some example embodiments, the functionality described herein will be implemented by instructions stored on a machine-readable medium (e.g., a machine-readable storage medium) for processing by a processor that processes such instructions to perform any one or more of the methodologies discussed herein. For example, the computer system of FIG. 4 includes one or more processors in a sample embodiment within which instructions (e.g., software, a program, an application, an applet, an app, or other executable code) are processed for causing the computer system of FIG. 4 to perform any one or more of the methodologies discussed herein. Also, the instructions may cause the processor(s) to execute the flow diagrams of FIGS. 7-10. The instructions transform the non-programmed machine into a particular machine programmed to carry out the described and illustrated functions in the manner described. In alternative embodiments, the machine of FIG. 4 operates as a standalone device or may be coupled (e.g., networked) to other machines. In a networked deployment, the machine of FIG. 4 may operate in the capacity of a server machine in a server-client network environment, or as a peer machine in a peer-to-peer (or distributed) network environment. The machine of FIG. 4 may comprise, but not be limited to, a server computer, a client computer, a personal computer (PC), a tablet computer, a laptop computer, a netbook, a set-top box (STB), a personal digital assistant (PDA), or any machine capable of executing the instructions sequentially or otherwise, that specify actions to be taken by machine of FIG. 4. Further, while only a single machine is illustrated, the term “machine” shall also be taken to include a collection of machines that individually or jointly execute the instructions to perform any one or more of the methodologies discussed herein.

The machine of FIG. 4 may include processors, memory, and I/O components, which may be configured to communicate with each other such as via a bus. In an example embodiment, the processors (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may execute instructions to implement the processes described herein. The term “processor” is intended to include multi-core processor that may comprise two or more independent processors (sometimes referred to as “cores”) that may execute instructions contemporaneously. The machine may include a single processor with a single core, a single processor with multiple cores (e.g., a multi-core process), multiple processors with a single core, multiple processors with multiples cores, or any combination thereof.

The memory/storage may include a memory such as a main memory, or other memory storage, and a storage unit, both accessible to the processors such as via a bus. The storage unit and memory store the instructions embodying any one or more of the methodologies or functions described herein. The instructions may also reside, completely or partially, within the memory, within the storage unit, within at least one of the processors (e.g., within the processor's cache memory), or any suitable combination thereof, during execution thereof by the machine. Accordingly, the memory, the storage unit, and the memory of processors are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., instructions) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components may include a wide variety of components to receive input, provide output, produce output, transmit information, exchange information, capture measurements, and so on. The specific I/O components that are included in a particular machine will depend on the type of machine. For example, portable machines such as mobile phones will likely include a touch input device or other such input mechanisms, while a headless server machine will likely not include such a touch input device. It will be appreciated that the I/O components may include many other components that are not shown in the figures. The I/O components are grouped according to functionality merely for simplifying the following discussion and the grouping is in no way limiting. In various example embodiments, the I/O components may include output components and input components. The output components may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components may include communication components operable to couple the machine to a network or devices via one or more couplings. For example, the communication components may include a network interface component or other suitable device to interface with the network. In further examples, communication component may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices may be another machine or any of a wide variety of peripheral devices (e.g., a peripheral device coupled via a Universal Serial Bus (USB)).

### Transmission Medium

In various example embodiments, one or more portions of the network including the system of FIG. 4 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network or a portion of the network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (IxRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to devices. The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Although an overview of the inventive subject matter has been described with reference to specific example embodiments, various modifications and changes may be made to these embodiments without departing from the broader scope of embodiments of the present disclosure. For example, while the sample embodiment described in detail above relates to a healthshare platform, those skilled in the art will appreciate that the platform described herein may be used to implement other member contribution processes in other environments such cell phone warranties, veterinary care, healthcare expenses, and costs experienced in niche luxury areas such as racehorses, airplane fuselages for private planes, and physical damage coverage for cars participating in ride-sharing services.

Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended expenses, along with the full range of equivalents to which such expenses are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended expenses. The specification and drawings are, accordingly, to be regarded in an illustrative rather than a restrictive sense.

What is claimed is:

1. A retrospective loss pooling platform, comprising:
a processor;
a display interface; and
a memory that stores instructions that, when executed by the processor, implement retrospective loss pooling of expenses for payment by:
creating a first data structure comprising loss pools of groups of members that are contractually obligated to collectively pay the expenses of other group members in respective time periods in response to expenses received from the members of the group in the respective time periods;
a second data structure receiving and validating expenses submitted by the group members in a given time period; and
the second data structure causing payment of expenses received and validated in the given time period from payment accounts of respective members in the group in accordance with the group's contractual obligations,
wherein the given time period occurs prior to payment.

2. The platform of claim 1, wherein the first data structure enforces contracts of service costs for the group negotiated on behalf of the individual members of the group and the expenses are paid in accordance with the negotiated service costs.

3. The platform of claim 1, wherein the first data structure enforces contracts of the group of members with an alliance including at least one other group to disperse service costs to a wider group of members whereby the expenses are paid proportionally by the group and the alliance.

4. The platform of claim 3, wherein the platform includes a database that stores a profile for each member of the group, each member profile including each member's group costs for previous time periods, as well as each member's alliance costs incurred as a result of the alliance formed with the at least one other group.

5. The platform of claim 3, wherein the group's contractual obligations include a limit that a member may pay in the given time period and the second data structure pulls payment from the alliance when the group's costs in the given time period exceeds the groups' members' limits.

6. The platform of claim 1, wherein the display interface enables the members of the group to manage membership of the group through a new member approval process and an expense challenge process.

7. A computer-implemented method for paying expenses of a loss pooling group using a retrospective loss pooling platform, comprising:
creating, using one or more processors, a first data structure comprising loss pools of group of members that are contractually obligated to collectively pay the expenses of other group members in respective time periods in response to expenses received from the members of the group in the respective time periods;
the one or more processors creating a second data structure for receiving and validating expenses submitted by the group members in a given time period; and
the second data structure causing payment of expenses received and validated in the given time period from payment accounts of respective members in the group in accordance with the group's contractual obligations,
wherein the given time period occurs prior to payment.

8. The method of claim 7, wherein the one or more processors enforce contracts of service costs for the group negotiated on behalf of the individual members of the group and payment of the expenses comprises paying the expenses in accordance with the negotiated service costs.

9. The method of claim 7, further comprising the one or more processors enforcing contracts of the group of members with an alliance including at least one other group of members to disperse service costs to a wider group of members wherein the payment of the expenses comprises paying the expenses proportionally by the group and the alliance.

10. The method of claim 9, further comprising storing each member's group costs for previous time periods, as well as each member's alliance costs incurred as a result of the alliance formed with the at least one other group in a database that stores a profile for each member of the group.

11. The method of claim 9, wherein the group's contractual obligations include a limit that a member may pay in the given time period and the payment of the expenses comprises the second data structure pulling payment from the alliance when the group's costs in the given time period exceeds the groups' members' limits.

12. The method of claim 7, further comprising enabling the members of the group to manage membership of the group through a new member approval process and an expense challenge process.

13. A non-transitory machine readable medium storing instructions that when executed by at least one processor implement a method for paying expenses using a retrospective loss pooling platform by the at least one processor:
creating loss pooling groups of members that are contractually obligated to collectively pay the expenses of other group members in respective time periods in response to expenses received from the members of the group in the respective time periods;
receiving and validating expenses submitted by the group members in a given time period; and
causing payment of expenses received and validated in the given time period from payment accounts of respective members in the group in accordance with the group's contractual obligations, wherein the given time period occurs prior to payment.

14. The medium of claim 13, further comprising instructions that when executed by the at least one processor enables the group to negotiate service costs on behalf of the individual members of the group and to pay the expenses in accordance with the negotiated service costs.

15. The method of claim 13, further comprising instructions that when executed by the at least one processor include adding the group of members to an alliance with at least one other group of members to disperse service costs to a wider group of members wherein the payment of the expenses comprises paying the expenses proportionally by the group and the alliance.

16. The method of claim 15, further comprising instructions that when executed by the at least one processor include storing each member's group costs for previous time periods, as well as each member's alliance costs incurred as a result of the alliance formed with the at least one other group in a database that stores a profile for each member of the group.

17. The method of claim 15, wherein the group's contractual obligations include a limit that a member may pay in the given time period further comprising instructions that when executed by the at least one processor include payment of the expenses by pulling payment from the alliance when the group's costs in the given time period exceeds the groups' members' limits.

18. The method of claim 13, further comprising instructions that when executed by the at least one processor include enabling the members of the group to manage membership of the group through a new member approval process and an expense challenge process.
